(19) United States
(12) Patent Application Publication
(10) Pub. No.: US 2019/0142042 A1
(43) Pub. Date: May 16, 2019

(54) PASTA SAUCE AND METHOD FOR PRODUCING SAME

(71) Applicants: MIZKAN HOLDINGS CO., LTD., Aichi (JP); MIZKAN CO., LTD., Aichi (JP)

(72) Inventor: Ryoichi Oda, Aichi (JP)

(73) Assignees: MIZKAN HOLDINGS CO., LTD., Aichi (JP); MIZKAN CO., LTD., Aichi (JP)

(21) Appl. No.: 16/250,011

(22) Filed: Jan. 17, 2019

Related U.S. Application Data
(63) Continuation of application No. PCT/JP2017/026797, filed on Jul. 25, 2017.

(30) Foreign Application Priority Data
Jul. 29, 2016 (JP) 2016-150398

(51) Int. Cl. A23L 23/00; A23L 7/113; A23L 3/16; A23L 27/00

(52) U.S. Cl. CPC A23L 23/00; A23L 7/113; A23V 2002/00; A23L 27/88; A23L 3/16

(57) ABSTRACT

Pasta sauce includes spicy seasoning, edible fat and oil, and at least one of ethanol or acetic acid. The pasta sauce may include 0.125 to 5.0% by weight of the ethanol and/or 0.0045 to 0.45% by weight of the acetic acid. A method for producing pasta sauce includes preparing a mixture by adding at least one of ethanol or acetic acid to a material solution containing spicy seasoning and edible fat and oil, and sterilizing the mixture by heating at a temperature lower than 100° C.

### TECHNICAL FIELD

One or more embodiments of the present invention relate to pasta sauce that can be used to cook a pasta dish in which spicy flavor and fresh feeling are enhanced, and a method for producing the pasta sauce.

### BACKGROUND

In current eating habits, the frequency of cooking at home while spending a considerable period of time has been reduced, and with progression of processing techniques, a variety of cooked processed foods have been developed. Pasta sauce is one of such cooked processed foods, and pasta sauce, which can be used to simply cook a pasta dish by being directly used or being heated in a microwave oven and being then mixed with boiled pasta, has been diffused in recent years. However, in order to save time and labor for cooking as much as possible, in general, such pasta sauce has comprised necessary ingredients and spicing seasoning therein, and has already been cooked by heating. Accordingly, tastes have become complicated, the original flavor and food texture of ingredients or spicing seasoning have been lost, or off-flavor or off-taste may be generated due to heat degeneration in some cases. In addition, pasta sauce, which has been subjected to a retorting treatment and has been treated at a temperature of higher than 100° C. in a pressurizing heating container for enhancing long-term preservation properties, may generate unpleasant odor such as so-called “retort odor,” or the oxidized odor of fat and oil, and thus, in that the original flavor of ingredients or spicy seasonings is masked and thereby, fresh feeling is impaired. Moreover, if many seasonings or aromatic materials are used in order to recover the impaired fresh feeling, complicated flavor is generated, and as a result, fresh feeling is increasingly impaired.

To date, in order to maintain the flavor components of pasta sauce or the fresh feeling of ingredients, various studies have been conducted. For example, Patent Literature 1 discloses pasta sauce, in which fermented alcohol comprising citrus fruits as main raw materials is mixed with tomatoes as raw materials, so that the original fresh feeling of the tomatoes are maintained even if the pasta sauce is subjected to a retorting treatment. However, citrus fruits have stimulating volatile citrus-based flavor components, and as a result, impart artificial fresh feeling to tomato flavor. As such, citrus fruits act to mask the original flavor of food materials. Moreover, Patent Literature 2 discloses heat-sterilized pasta sauce, in which eggshell powders are mixed with basil-containing pasta sauce, so that the flavor of the basil can be maintained even after completion of the heat sterilization. However, in the method of Patent Literature 2, eggshell powders are used as a carrier for retaining the flavor components of basil, so as to suppress the release of the flavor components of the basil due to heat sterilization, and thus, this method is not intended to promote the release of the flavor components of the basil, when the pasta sauce is mixed with boiled pasta. Further, since the eggshell powders used therein are subjected to a pulverization treatment, it takes enormous labor and time to prepare this pasta sauce, and thereby, in general, this pasta sauce cannot be readily utilized as a material to be mixed with food products. Furthermore, Patent Literature 3 discloses basil sauce packed in a container, in which ethanol is added to basil-mixed pasta sauce and the pH value is adjusted to pH 6.5 to 8.0, so that the favorable aroma specific to basil can be maintained even after storage. However, in Patent Literature 3, in order to obtain the effect of maintaining the aroma of basil for a long period of time, complicated operations are carried out, such that the basil leaves are finely ground in edible fat and oil to prepare a paste, so that favorable flavor components specific to basil are sufficiently extracted in the edible fat and oil, and the pH of the pasta sauce is adjusted to be in a specific pH range with an alkaline agent. Further, since ethanol is added not only for extraction of the flavor components of basil, but also for the purpose of adjusting water activity to improve preservability (bacteriostasis), the ethanol concentration of hydrous ethanol used to add ethanol herein is restricted.

### CITATION LIST

### Patent Literature

### Patent Literature 1: Japanese Patent No. 4997133

### Patent Literature 2: JP Patent Publication (Kokai) No. 2009-89679 A

### Patent Literature 3: JP Patent Publication (Kokai) No. 2009-131209 A

Conventional pasta sauce has been used to save the time and labor for cooking pasta dishes. At the same time, however, the taste of the pasta sauce has been complicated by mixing many types of raw materials, and also, retort odor or the oxidized odor of fat and oil has been generated as a result of a retorting treatment, so that the fresh flavor (taste and aroma) and food texture originally possessed by ingredients or spicy seasonings have been lost. Accordingly, the quality of the conventional pasta sauce has not been satisfactory.

### SUMMARY

One or more embodiments of the present invention provide pasta sauce, which can be used to simply cook a pasta dish with enhanced spicy flavor and fresh feeling, and can be produced by simple steps without using special raw materials.

The present inventors have conducted intensive studies regarding the raw materials of pasta sauce that is used by being mixed with ingredients and boiled pasta. As a result, the present inventors have found that, when a predetermined amount of at least one of ethanol and acetic acid is mixed with pasta sauce containing spicy seasonings and edible fat and oil and the obtained mixture is then mixed (blended) with ingredients and boiled pasta, a pasta dish with enhanced spicy flavor and fresh feeling can be obtained.

In general, upon preparation of pasta sauce, food materials containing ethanol or acetic acid, such as red wine or balsamic vinegar, are used in some cases. The purpose of using such food materials is addition of flavors specific to red wine or balsamic vinegar, just as secret taste, secret flavor or the like, to the pasta sauce. After addition of such food materials, in general, the sauce is sufficiently stewed or is heated (“flambe”) in a flying pan. As a result, volatile ethanol or acetic acid is volatized during cooking, and thus, when the present pasta sauce is mixed with boiled pasta and the pasta is finally eaten, almost no ethanol or acetic acid remains. In contrast, in the case of the pasta sauce according to one or more embodiments of the present invention, when the pasta sauce is mixed with boiled pasta and the pasta is finally eaten, ethanol or acetic acid is volatized. Accordingly, the pasta sauce according to one or more embodiments of the present invention is different from common pasta sauce, in terms of the addition of ethanol or acetic acid to the pasta sauce.

Specifically, one or more embodiments of the present invention include the following:

(1) Pasta sauce containing spicy seasoning and edible fat and oil, which comprises at least one of ethanol and acetic acid.
(2) The pasta sauce according to the above (1), wherein the content of the ethanol is 0.125% to 5.0% by weight based on the total weight of the pasta sauce, and/or the content of the acetic acid is 0.0045% to 0.45% by weight based on the total weight of the pasta sauce.
(3) The pasta sauce according to the above (1) or (2), which is not emulsified.
(4) The pasta sauce according to any one of the above (1) to (3), which is used by being mixed with ingredients and boiled pasta.
(5) The pasta sauce according to any one of the above (1) to (4), which has been sterilized by heating at lower than 100° C.
(6) A method for producing pasta sauce, comprising a step of adding at least one of ethanol and acetic acid to a material solution containing spicy seasoning and edible fat and oil, and a step of sterilizing the mixture obtained in the aforementioned step by heating at lower than 100° C.
(7) The method for producing pasta sauce according to the above (6), wherein at least one of ethanol and acetic acid is added to the material solution containing spicy seasoning and edible fat and oil, so that the content of the ethanol becomes 0.125% to 5.0% by weight based on the total weight of the pasta sauce, and/or the content of the acetic acid becomes 0.0045% to 0.45% by weight based on the total weight of the pasta sauce.
(8) The method for producing pasta sauce according to the above (6) or (7), wherein the pasta sauce is not emulsified.
(9) A method for enhancing the spicy flavor and fresh feeling of a pasta dish, comprising mixing the pasta sauce according to any one of the above (1) to (5) with ingredients and boiled pasta.
(10) The method for enhancing the spicy flavor and fresh feeling of a pasta dish according to the above (9), wherein the pasta sauce is mixed at a ratio of 3 to 30 parts by weight with a total of 100 parts by weight of the ingredients and the boiled pasta.
(11) The method for enhancing the spicy flavor and fresh feeling of a pasta dish according to the above (9) or (10), wherein the ingredients are boiled together with the pasta, or the ingredients are cooked with heat, separately from the pasta.

According to one or more embodiments of the present invention, there is provided pasta sauce, in which the spicy flavor and fresh feeling of spicy seasonings or aromatic materials comprised in the pasta sauce are strongly felt, and the pasta sauce can be used to readily cook at home a pasta dish, which has fresh food taste, and the fresh and chewy food texture of ingredients mixed with the pasta sauce. Since the pasta sauce according to one or more embodiments of the present invention is subjected to a heat sterilization treatment at a temperature of lower than 100° C., retort odor or the oxidized odor of fat and oil is not generated. Moreover, these effects of the present pasta sauce are not changed even after long-term preservation thereof, and are stably maintained.

The present application claims priority from Japanese Patent Application No. 2016-150398, filed on Jul. 29, 2016; the disclosure of which is hereby incorporated by reference.

### DETAILED DESCRIPTION OF EMBODIMENTS

The pasta sauce according to one or more embodiments of the present invention is a pasta sauce containing spicy seasoning and edible fat and oil, and the pasta sauce is characterized in that it comprises a predetermined amount of at least one of ethanol and acetic acid.

The preferable form of the pasta sauce according to one or more embodiments of the present invention is not subjected to an emulsification treatment, and is in a non-emulsified state in which an oil phase and a water phase are separated from each other, because the spicy flavor and fresh feeling of a pasta dish are easily obtained when the pasta sauce is mixed with ingredients and hot pasta immediately after boiling. Moreover, since the pasta sauce according to one or more embodiments of the present invention is used by being mixed with ingredients and boiled pasta, main ingredients for a pasta dish are not contained in the present pasta sauce.

In one or more embodiments of the present invention, the term “spicy flavor” is used to mean the specific aroma and stimulating taste of spicy seasonings or aromatic materials contained in the pasta sauce. In addition, the term “fresh feeling” is used to mean fresh flavor and food texture originally possessed by ingredients to be mixed with the pasta sauce, and also, fresh flavor originally possessed by spicy seasonings or aromatic materials contained in the pasta sauce. The term “flavor” is used herein to mean the comprehensive sensation of aroma and taste, which is felt when a food product is added into the mouth and is chewed.

The “spicy seasoning” used in one or more embodiments of the present invention means a part of a plant body (e.g., the fruit, pericarp, flower, bud, bark, stalk, leaf, seed, root, rhizome, etc., of a plant), which has specific aroma, stimulating taste and color tone, and is mixed into foods or beverages for the purpose of aromatization, deodorization, seasoning, coloration, etc. The spicy seasoning includes spice and herb.

Among such spicy seasonings, the spice means a spicy seasoning, from which stalks, leaves and flowers are excluded as utilized sites. Examples of the spice include pepper (black pepper, white pepper, and red pepper), garlic, ginger, sesame (sesame seeds), capsicum, horseradish (Armoracia rusticana), mustard, poppy seeds, yuzu, nutmeg, cinnamon, paprika, cardamom, cumin, saffron, allspice, clove, Japanese pepper, orange peel, fennel, licorice, fenugreek, Dill seed, Sichuan pepper, long pepper, and olive fruit. On the other hand, among such spicy seasonings, the herb means a spicy seasoning, the stalks, leaves and flowers of which are utilized. Examples of the herb include watercress, coriander, Japanese basil, celery, tarragon, chives, chervil, sage, thyme, laurel, leek, parsley, mustard green (Brassica juncea), Japanese ginger, mugwort, basil, oregano, rosemary, peppermint, savory, lemon grass, Dill, Japanese horseradish leaves, and Japanese pepper leaves.

In one or more embodiments of the present invention, the above-described spicy seasonings may be used alone as a single type, or may also be used in combination of two or more types. Among the above-described spicy seasonings, black pepper may be preferable because it has particularly strong olfactory stimulation and high effects on the flavor of the entire pasta sauce and desired spicy flavor is easily obtained. The content of the spicy seasoning in the pasta sauce according to one or more embodiments of the present invention may be determined, as appropriate, depending on the type and number of used spicy seasonings, and the effect of obtaining desired spicy flavor. However, the spicy seasoning has an extremely high flavor titer, and so, if the spicy seasoning is used in an extremely large amount, the balance between the spicy flavor and fresh feeling of a pasta dish is deteriorated. Hence, the total content of the spicy seasoning used in the pasta sauce may be, at a dry weight, 0.01% to 3% by weight, and more preferably 0.02% to 2% by weight. Moreover, from the viewpoint of diffusion of flavor components from the pasta sauce, the size of the spicy seasoning may be 5 mm mesh-pass, and more preferably 3 mm mesh-pass.

Furthermore, in one or more embodiments of the present invention, the food material having favorable flavor and taste, which is other than the above-described spicy seasoning (spice or herb), is referred to as an “aromatic material.” The aromatic material can be used together with the above-described spicy seasoning, and it may be either a vegetable aromatic material or an animal aromatic material. Examples of the aromatic material include aromatic vegetables other than the above-described herb (tomato, broccoli, Japanese mustard spinach, pumpkin, carrot, onion, green pepper, etc.), nuts and seeds (almond, peanut, pine nut, sweet corn, coconut, etc.), fruits (apple, olive, grape fruit, sudachi, pine apple, grape, mango, peach, yuzu, orange, lime, lemon, kabosu, plum, etc.), seafood (sardines, shrimp, crab, scallops, squid, octopus, clams, oysters, tuna, cod roe, etc.), meats of livestock animals (beef, pork, chicken, etc.), and processed products of these materials. Examples of the processed product that is used herein include an extract, a dried product, a milled product (paste and puree), a granulated product, and a powdery product.

The “edible fat and oil” used in one or more embodiments of the present invention means fat and oil originated from plants, or fat and oil originated from animals. Examples of the fat and oil originated from plants include linseed oil, Akebia oil, avocado oil, almond oil, Argane oil, olive oil, mustard oil, canola oil, walnut oil, cranberry seed oil, grape seed oil, poppy seed oil, wheat germ oil, rice oil, corn oil, sesame oil, sasanqua oil, safflower oil, perilla oil, soybean oil, tea oil, camellia oil, rapeseed oil, palm oil, pumpkin seed oil, castor oil, sunflower oil, pistachio oil, peanut oil, hazelnut oil, macadamia nut oil, cotton seed oil, and coconut oil. Examples of the fat and oil originated from animals include butter, beef tallow, lard, mutton tallow, chicken fat, and fish oil. In one or more embodiments, the edible fat and oil, which are a solid at normal temperature, are preferably hydrogenated, so that the fat and oil are converted to a liquid or semi-solid state. In one or more embodiments of the present invention, depending on the used spicy seasonings or ingredients, the edible fat and oil, which do not inhibit the spicy flavor and fresh feeling of the spicy seasonings or ingredients, may be selected, as appropriate, and thus, the type of the edible fat and oil is not limited. The above-described edible fats and oils may be used alone as a single type, or may also be used in combination of two or more types. The content of the edible fat and oil in the pasta sauce according to one or more embodiments of the present invention may be determined, as appropriate, depending on the type or shape of the used edible fat and oil. In one or more embodiments, the edible fat and oil is used in an amount of 10% to 95% by weight, and preferably approximately 10% to 75% by weight, based on the total weight of the pasta sauce.

The pasta sauce according to one or more embodiments of the present invention may comprise “ethanol” in the form of an ethanol-containing product. Such an ethanol-containing product is not limited in terms of type and the concentration of contained ethanol, as long as it is acceptable as a food or a food additive, does not inhibit desired spicy flavor and fresh feeling, and is able to add ethanol in a predetermined content range into the pasta sauce. Examples of such an ethanol-containing product include commercially available ethanol preparations, distilled alcohols [ethanol obtained by fermenting and distilling raw materials comprising grains (rice, wheat, corn, sugarcane, etc.) or potatoes (sweet potatoes, potatoes, etc.) and molasses, alcohols (Japanese sake, shochu, wine, etc.), and sweet sake, which are commonly used as food additives. Among these, ethanol preparations or distilled alcohols containing a high concentration of ethanol, which have a high content of ethanol and weak flavor derived from raw materials, may be preferable. These ethanol-containing products may be used alone, or may also be used in combination of two or more types.

The content of the ethanol in the pasta sauce according to one or more embodiments of the present invention is 0.125% to 5.0% by weight, preferably 0.25% to 5.0% by weight, and more preferably 1.0% to 5.0% by weight, based on the total weight of the pasta sauce. If the content of the ethanol in the pasta sauce is within the above-described range, spicy flavor and fresh feeling exhibited by non-polar flavor components in spicy seasonings, aromatic materials and/or ingredients are strongly felt in the pasta cooked using the present pasta sauce. If the content of the ethanol is lower than 0.125% by weight, the above-described effects cannot be obtained. On the other hand, if content of the ethanol is higher than 5.0%/o by weight, the bitter taste and stimulating odor of ethanol are unfavorably felt.

The pasta sauce according to one or more embodiments of the present invention may comprise “acetic acid” in the form of an acetic acid-containing product. Such an acetic acid-containing product is not limited in terms of type and the concentration of contained acetic acid, as long as it is acceptable as a food or a food additive, does not inhibit desired spicy flavor and fresh feeling, and is able to add acetic acid in a predetermined content range into the pasta sauce. The acetic acid-containing product used in one or more embodiments of the present invention is, for example, vinegar. Such vinegar includes: brewed vinegar produced using, as raw materials, grains such as rice or wheat or fruit juice; and synthetic vinegar prepared by adding a seasoning such as sugar to glacial acetic acid or a diluted solution of acetic acid, or further adding brewed vinegar to the above mixture. Both of the above vinegars can be used herein. Examples of the brewed vinegar include: grain vinegar (rice vinegar, brown rice vinegar, black vinegar, sake lees vinegar, malt vinegar, adlay vinegar, soybean vinegar, etc.); fruit vinegar (apple vinegar, grape vinegar, lemon vinegar, kabosu vinegar, ume vinegar, wine vinegar, balsamico vinegar, etc.); alcoholic vinegar produced by acetic acid fermentation using ethanol as a raw material; and Chinese vinegar. An example of the synthetic vinegar is vinegar prepared by diluting glacial acetic acid or acetic acid with water, as appropriate. Among these vinegars, alcoholic vinegar and synthetic vinegar having a high concentration of acetic acid, which have a high content of the acetic acid and weak flavor derived from raw materials, may be preferable. These vinegars may be used alone, or may also be used in combination of two or more types.

In one or more embodiments, the content of the acetic acid is 0.0045% to 0.45% by weight, preferably 0.009% to 0.45% by weight, and more preferably 0.015% to 0.15% by weight, based on the total weight of the pasta sauce. If the content of the acetic acid in the pasta sauce is within the above-described range, the spicy flavor and fresh feeling of polar flavor components contained in the spicy seasonings and/or ingredients are felt strongly in the pasta cooked using the pasta sauce. If the content of the acetic acid is lower than 0.0045% by weight, the above-described effects cannot be obtained. On the other hand, if the content of the acetic acid is higher than 0.45% by weight, the acetic acid unfavorably causes stimulating odor and acid taste.

The pasta sauce according to one or more embodiments of the present invention may comprise at least one of ethanol and acetic acid, but the combined use thereof may be preferable. If ethanol is used in combination with acetic acid, polar flavor components are mixed with non-polar flavor components in spicy seasonings and/or ingredients, and the spicy flavor and fresh feeling provided by the flavor components are complementarily and synergistically felt. If the content of the ethanol and/or the acetic acid is lower than the lower limit value in the above-described range, the effects are not exhibited. On the other hand, if the content of the ethanol and/or the acetic acid is higher than the upper limit value in the above-described range, the flavor of ethanol and/or acetic acid unfavorably inhibits the spicy flavor and fresh feeling provided by flavor components contained in spicy seasonings and/or ingredients.

In addition to the above-described edible fat and oil, spicy seasoning, ethanol, and acetic acid, the pasta sauce according to one or more embodiments of the present invention may also comprise common raw materials and additives generally used in pasta sauce in a range that does not impair the effects according to one or more embodiments of the present invention. Examples of the common raw materials and additives include the above-described aromatic materials, common salts, sugars (sugar, fructose, glucose, starch syrup, isomerized glucose syrup, etc.), umami seasonings (protein hydrolysate, yeast extract, etc.), amino acid-based seasonings (glycine, alanine, sodium glutamate, etc.), nucleic acid-based seasonings (sodium inosinate, sodium guanylate, etc.), thickening agents (gums such as xanthan gum, locust gum or carrageenan, starches such as wheat starch or corn starch, etc.), acidulants (citric acid, lactic acid, malic acid, tartaric acid, etc.), antioxidants (tocopherol, cysteine hydrochloride, etc.), taste improvers (for example, a bitter taste suppressor, etc.), pH adjusters, and coloring agents. The additive amount of such a raw material or additive may be adjusted, as appropriate, depending on the desired quality.

The “pasta sauce” according to one or more embodiments of the present invention is mixed with ingredients and boiled pasta, so that a pasta dish providing enhanced spicy flavor and fresh feeling, when it is eaten, can be prepared. The pasta may be boiled according to an ordinary method, and the degree of boiling the pasta may be adjusted, as appropriate, in terms of food texture and flavor.

In accordance with classification of the pasta by cooking methods, the “pasta” includes: pasta asciutta prepared by boiling pasta, removing water from the pasta, and mixing it with sauce; pasta al forno prepared by baking it in an oven; and pasta in brodo that is pasta used as ingredients for soup. Among these types of pastas, the pasta, to which the pasta sauce according to one or more embodiments of the present invention is applied, may be preferably pasta asciutta that is prepared by boiling pasta, removing water from the pasta, and mixing it with sauce, because the effect of the pasta sauce according to one or more embodiments of the present invention to enhance the spicy flavor and fresh feeling of spicy seasonings and/or ingredients upon eating the pasta is most significantly exhibited to the pasta sauce. However, the pasta sauce according to one or more embodiments of the present invention can also be applied to other types of pastas, and are not limited.

Moreover, the type of the “pasta” may be either dry pasta (pasta secca) or fresh pasta (pasta fresca), and the shape of the “pasta” may be either long pasta or short pasta. Examples of the long pasta include spaghetti, spaghettini, vermicelli, capellini, capelli d'angelo, pappardelle, tagliatelle, fettuccine, zite, bucatini, linguine, lasagnette ricce, lazagne, and chitarra. Examples of the short pasta include maccheroni, rigatoni, maniche, pennne, farfalle, conchiglie, fusilli, spirale, cavatappi, cappelletti, lumachine, ruote, risoni, semini, orecchiette, gnocchi, and ravioli.

In one or more embodiments of the present invention, the term “ingredient” is used to mean a food material that is a main food for a pasta dish, wherein the food material is prepared separately from pasta sauce and is excluded from the pasta sauce. Examples of such an ingredient include: vegetables (green vegetables such as cabbage, spinach, Chinese cabbage, Japanese mustard spinach, or bok choy; root vegetables such as carrot, Japanese white radish, or onion; fruit vegetables such as tomato, green pepper, or eggplant; stem vegetables such as asparagus or bamboo sprout; and flower vegetables such as broccoli or cauliflower), mushrooms (shimeji mushrooms, shiitake mushrooms, mushrooms, king oyster mushrooms, maitake mushrooms, etc.), beans (soybeans, peas, lentils, chickpeas, Egyptian beans, etc.), fruits (apple, pine apple, strawberry, peach, papaya, mango, etc.), seafood (squid, shrimp, clams, scallops, mussels, etc.), meats of domesticated animals or processed meat products (beef, chicken, pork, ham, bacon, sausage, etc.), seaweeds (hijiki, wakame seaweed, kelp, etc.), eggs, and the processed products thereof. One type, or two or more types may be selected from these ingredients and may be used. The ingredients used in one or more embodiments of the present invention are preferably vegetables, the fresh feeling of which is easily damaged by heat cooking. Ingredients, which do not require heat cooking, can be directly mixed with boiled pasta and can be then used. On the other hand, in order to cook ingredients requiring heat cooking, a method comprising simultaneously adding ingredients together with pasta, upon boiling the pasta, and then boiling the ingredients together with the pasta, may be preferably applied in terms of ease of cooking. Otherwise, it is also possible to cook ingredients by heating, separately from pasta, and then to mix the ingredients with boiled pasta.

The pasta sauce according to one or more embodiments of the present invention can be produced by a method comprising a step of adding at least one of ethanol and acetic acid to a material solution containing spicy seasoning and edible fat and oil and mixing them with each other, and a step of sterilizing the mixture obtained in the above step by heating it at a temperature of lower than 100° C.

The step of adding at least one of ethanol and acetic acid to a material solution containing spicy seasoning and edible fat and oil may be carried out according to an ordinary method, with the exception that the ethanol and/or acetic acid are added to the material solution such that the content of the ethanol and/or the acetic acid in the pasta sauce can be within the above-described range. Specifically, edible fat and oil, spicy seasoning, at least one of ethanol and acetic acid, and other raw materials may be added to water, and they may be then mixed and stirred. The order of adding these materials is not particularly limited. In addition, during the mixing and stirring, heating may be carried out as necessary. In order to prevent volatilization of ethanol and/or acetic acid, the heating may be preferably carried out at a temperature of 10° C. to 60° C.

Subsequently, in order to prevent volatilization of ethanol and/or acetic acid, the raw material mixture obtained in the above-described step is sterilized by heating under hermetically sealed conditions such as the inside of a hermetically sealed tank or a plate heater. After completion of the above-described heat sterilization, the reaction mixture is filled into a hermetically sealable container through a hermetically sealed pipe, so as to prepare a product that can be distributed at normal temperature and/or can be stored at normal temperature for a long period of time. The container in which the raw material mixture is contained is not particularly limited in terms of material or shape, as long as it is capable of hermetically sealing the mixture and does not give passage to ethanol and/or acetic acid. Examples of the container include plastic containers, pouches (polyethylene pouch and aluminum pouch), PET bottles, steel cans, aluminum cans, and bottle containers.

The above-described heat sterilization treatment is carried out at a heat-sterilization temperature of lower than 100° C. (what is called, “low-temperature heat sterilization treatment”), and for example, it can be carried out by a heating method involving vapor, hot water, etc. In one or more embodiments, the temperature applied to the heat sterilization treatment is preferably 60° C. or higher and lower than 100° C., more preferably 60° C. to 95° C., and further preferably 65° C. to 90° C. It is to be noted that the temperature applied herein means the center temperature of a product. The time applied to the heat sterilization treatment may be adjusted, as appropriate, depending on temperature, and in one or more embodiments, it is preferably 3 to 60 minutes, and more preferably 3 to 30 minutes. When the heat sterilization treatment is performed in the above-described temperature range, the heat degradation of flavor components exhibiting spicy flavor and fresh feeling in the spicy seasonings contained in the pasta sauce can be suppressed, and also, generation of the oxidized odor of edible fat and oil causing damage to the spicy flavor and fresh feeling can be suppressed. In contrast, a heat sterilization treatment performed at 100° C. or higher, for example, a retorting treatment generates retort odor or the odor of fat and oil, which causes damage to the spicy flavor and fresh feeling, and thus, it may not be preferable to apply this treatment. The pasta sauce according to one or more embodiments of the present invention has bacteriostatic effects, by which it can be preserved at normal temperature for a long period of time, even after it has been subjected to a low-temperature heat sterilization treatment.

The pasta sauce according to one or more embodiments of the present invention is used by being mixed with ingredients and boiled pasta. From the viewpoint of the ease of uniformly mixing into ingredients and boiled pasta and good balance between the taste and food texture of a pasta dish, the pasta sauce according to one or more embodiments of the present invention may be mixed into the ingredients and the boiled pasta at a ratio of 3 to 30 parts by weight, and preferably 3 to 20 parts by weight, based on 100 parts by weight (total amount) of the ingredient and the boiled pasta.

### EXAMPLES

Hereinafter, one or more embodiments of the present invention will be more specifically described in the following examples. However, these examples are not intended to limit the scope of the present invention.

### (Test Example 1) Analysis of Components Added to the Pasta Sauce

### (1) Preparation of Test Sample

Main raw materials comprising spicy seasonings and edible fat and oil were mixed with components to be evaluated at the mixing amounts shown in Table 1 (total amount: 1000 g), and the obtained mixture was then placed in a hermetically sealed container. The mixture was subjected to a heat sterilization treatment at 90° C. for 5 minutes, and was then cooled to normal temperature, thereby preparing pasta sauces to be used as test samples (Test Nos. 1 to 8). As components to be evaluated, taste-enhancing components (nucleic acid, sodium succinate, sodium glutamate, and yeast extract), a viscosity-imparting component (xanthan gum), a volatile component (ethanol preparation (ethanol concentration: 50%° by weight), and high-acidity vinegar (alcoholic vinegar; acetic acid concentration: 15% by weight)) were used.

### (2) Sensory Evaluation

Commercially available dry spaghetti and ingredients (cabbages cut into a bite-size) were boiled. With the boiled pasta and ingredients (total amount: 200 g), 20 g of the pasta sauce prepared in the above (1) was mixed, and thereafter, spicy flavor and fresh feeling were evaluated when the pasta dish was eaten. The evaluation was carried out by five professional panelists in accordance with the following criteria.

### Evaluation Criteria (Spicy Flavor and Fresh Feeling)

A: Spicy flavor and fresh feeling are felt.

B: Spicy flavor and fresh feeling are slightly felt.

C: Spicy flavor and fresh feeling are hardly felt.

D: Spicy flavor and fresh feeling are not felt.

Moreover, with regard to comprehensive evaluation of the taste of the pasta dish as a whole, taste and food texture were evaluated in accordance with the following criteria.

### Evaluation Criteria (Comprehensive Evaluation of the Taste of the Pasta Dish as a Whole)

A: Pasta dish has significantly excellent taste and food texture.

B: Pasta dish has excellent taste and food texture.

C: Pasta hardly has excellent taste and food texture.

D: Pasta dish does not have excellent taste and food texture.

The results are shown in Table 1.

TABLE 1

| Test No. | Test No. | Test No. | Test No. | Test No. | Test No. | Test No. | Test No. |
|---|---|---|---|---|---|---|---|
| 1 | 2 | 3 | 4 | 5 | 6 | 7 | 8 |

Main raw materials (% by weight)

| | | | | | | | | |
|---|---|---|---|---|---|---|---|---|
| Spicy seasonings(Black pepper | 0.1 | 0.1 | 0.1 | 0.1 | 0.1 | 0.1 | 0.1 | 0.1 |
| powder) | | | | | | | | |
| Spicy seasonings(Roasted garlic | 02 | 0.2 | 0.2 | 0.2 | 0.2 | 0.2 | 0.2 | 0.2 |
| base) | | | | | | | | |
| Olive oil | 30 | 30 | 30 | 30 | 30 | 30 | 30 | 30 |
| Tomato paste | 30 | 30 | 30 | 30 | 30 | 30 | 30 | 30 |
| Sugar | 3 | 3 | 3 | 3 | 3 | 3 | 3 | 3 |
| Common salt | 6 | 6 | 6 | 6 | 6 | 6 | 6 | 6 |
| Water | Balance | Balance | Balance | Balance | Balance | Balance | Balance | Balance |

Evaluated components (% by weight)

| | | | | | | | | |
|---|---|---|---|---|---|---|---|---|
| Nucleic acid | | 0.05 | | | | | | |
| Na succinate | | | 0.03 | | | | | |
| Na glutamate | | | | 1.0 | | | | |
| Xanthan gum | | | | | 0.2 | | | |
| Yeast extract | | | | | | 0.2 | | |
| High-acidity vinegar (acetic acid: | | | | | | | 0.1 | |
| 15% by weight) | | | | | | | | |
| Ethanol preparation (ethanol: | | | | | | | | 5.0 |
| 50% by weight) | | | | | | | | |
| Total | 100 | 100 | 100 | 100 | 100 | 100 | 100 | 100 |

Ethanol content (% by weight)

| | | | | | | | |
|---|---|---|---|---|---|---|---|
| 0 | 0 | 0 | 0 | 0 | 0 | 0 | 2.5 |

Acetic acid content (% by weight)

| | | | | | | | |
|---|---|---|---|---|---|---|---|
| 0 | 0 | 0 | 0 | 0 | 0 | 0.015 | 0 |

Spicy flavor and fresh feeling

| | | | | | | | |
|---|---|---|---|---|---|---|---|
| C | D | C | D | C | D | B | A |

Comprehensive evaluation

| | | | | | | | |
|---|---|---|---|---|---|---|---|
| C | D | C | D | C | D | B | A |

Remarks

| | | | | | | | |
|---|---|---|---|---|---|---|---|
| (Control) | Slightly | No | Slightly | No | Heavy | Slight | Aroma |
| | heavy taste | difference | heavy taste | difference | taste | aroma | |

As shown in Table 1, when the ethanol preparation was added to the pasta sauce, spicy flavor and fresh feeling were felt most strongly, and also, the taste and food texture of the pasta were evaluated to be most excellent (Test No. 8). Also, when high-acidity vinegar (alcoholic vinegar) was added to the pasta sauce, spicy flavor and fresh feeling were felt, although they were slightly weak, and further, the taste and food texture of the pasta were evaluated to be excellent (Test No. 7). In contrast, when a taste-enhancing component or a viscosity-imparting component was added to the pasta sauce, spicy flavor and fresh feeling were impaired (Test Nos. 2 to 6).

In the cases of the two types of pasta sauces, to which either the ethanol preparation or the high-acidity vinegar (alcoholic vinegar) was added, when the pasta sauce was mixed with the boiled pasta and ingredients, the spicy flavor of the spicy seasonings in the pasta sauce came out, and with such spicy flavor, the fresh feeling of tomatoes in the pasta sauce and ingredients (cabbages) was also felt. Besides, it was confirmed that content of the ethanol in Test No. 8 and the content of the acetic acid in Test No. 7, in which spicy flavor and fresh feeling were felt and evaluation of the taste and food texture of pasta was also excellent, were not reduced in the process of producing the pasta sauces.

### (Test Example 2) Analysis of Content of Ethanol

Regarding the ethanol preparation, the effects of which were confirmed in Test Example 1, the content range of ethanol in pasta sauce was analyzed. Main raw materials comprising spicy seasonings and edible fat and oil were mixed with the ethanol preparation at the mixing amounts shown in Table 2, and the obtained mixture was subjected to a heat sterilization treatment (90° C., 5 min), thereby preparing pasta sauces (Test Nos. 9 to 17). Using these pasta sauces, pasta was cooked in the same manner as that of Test Example 1, and sensory evaluation was then carried out. The results are shown in Table 2. Besides, the term “aroma” described in the remarks of Table 2 means the fresh spicy flavor of pepper contained in the pasta sauce.

TABLE 2

| Test No. | Test No. | Test No. | Test No. | Test No. | Test No. | Test No. | Test No. | Test No. |
|---|---|---|---|---|---|---|---|---|
| 9 | 10 | 11 | 12 | 13 | 14 | 15 | 16 | 17 |

Main raw materials (% by weight)

| | | | | | | | | | |
|---|---|---|---|---|---|---|---|---|---|
| Spicy seasonings(Black pepper | 0.1 | 0.1 | 0.1 | 0.1 | 0.1 | 0.1 | 0.1 | 0.1 | 0.1 |
| powder) | | | | | | | | | |
| Spicy seasonings(Roasted garlic | 0.2 | 0.2 | 0.2 | 0.2 | 0.2 | 0.2 | 0.2 | 0.2 | 0.2 |
| base) | | | | | | | | | |
| Olive oil | 30 | 30 | 30 | 30 | 30 | 30 | 30 | 30 | 30 |
| Tomato paste | 30 | 30 | 30 | 30 | 30 | 30 | 30 | 30 | 30 |
| Sugar | 3 | 3 | 3 | 3 | 3 | 3 | 3 | 3 | 3 |
| Common salt | 6 | 6 | 6 | 6 | 6 | 6 | 6 | 6 | 6 |
| Water | Balance | Balance | Balance | Balance | Balance | Balance | Balance | Balance | Balance |

Added components (% by weight)

| | | | | | | | | | |
|---|---|---|---|---|---|---|---|---|---|
| Ethanol preparation (ethanol: | 0 | 0.1 | 0.25 | 0.5 | 2.0 | 5.0 | 7.5 | 10.0 | 12.5 |
| 50% by weight) | | | | | | | | | |
| Total | 100 | 100 | 100 | 100 | 100 | 100 | 100 | 100 | 100 |

Ethanol content (% by weight)

| | | | | | | | | |
|---|---|---|---|---|---|---|---|---|
| 0 | 0.05 | 0.125 | 0.25 | 1.0 | 2.5 | 3.75 | 5.0 | 6.25 |

Spicy favor and fresh feeling

| | | | | | | | | |
|---|---|---|---|---|---|---|---|---|
| C | C | B | B | A | A | A | A | D |

Comprehensive evaluation

| | | | | | | | | |
|---|---|---|---|---|---|---|---|---|
| C | C | B | B | A | A | A | A | D |

Remarks

| | | | | | | | | |
|---|---|---|---|---|---|---|---|---|
| (Control) | No | Slight | Aroma | Strong | Strong | Strong | Strong | Bitter taste and |
| | difference | aroma | | aroma | aroma | aroma | aroma | stimulating |
| | | | | | | | | odor of ethanol |

As shown in Table 2, when the content of the ethanol in the pasta sauce was in the range of 0.125% to 5.0% by weight, the spicy flavor of spicy seasonings (pepper and garlic) was felt upon the mixing of the pasta sauce with the boiled pasta and ingredients, and the fresh feeling of ingredients was not impaired (Test Nos. 11, 12, 13, 14, 15, and 16). If content of the ethanol was smaller than 0.125% by weight, the above-described effects could not be obtained (Test Nos. 9 and 10). On the other hand, if content of the ethanol was larger than 5.0% by weight, the stimulating odor of ethanol came out, and regarding the taste, the bitter taste and stimulating odor of ethanol were felt, and the quality was impaired (Test No. 17). In the case of using ethanol, in particular, the fresh spicy aroma of the spicy seasonings (pepper and garlic) came out. This is considered because, since ethanol is a substance having low polarity, flavor components having low polarity and exhibiting spicy flavor contained in the spicy seasonings appeared with volatilization of the ethanol at a low boiling point. In addition, spicy taste derived from the spicy seasonings was also felt strongly. This is considered because the stimulation of the nasal cavity by flavor components exhibiting spicy aroma contained in the spicy seasonings is closely related with taste reception in the oral cavity. Besides, it was confirmed that content of the ethanol in Test Nos. 11 to 16 was not reduced in the process of producing the pasta sauce.

### (Test Example 3) Analysis of Content of Acetic Acid

Regarding the high-acidity vinegar (alcoholic vinegar), the effects of which were confirmed in Test Example 1, the content range of the acetic acid in the pasta sauce was analyzed. Main raw materials comprising spicy seasonings and edible fat and oil were mixed with vinegar at the mixing amounts shown in Table 3, and the obtained mixture was then subjected to a heat sterilization treatment (90° C., 5 min), thereby preparing pasta sauces (Test Nos. 18 to 26). Using these pasta sauces, pasta was cooked in the same manner as that of Test Example 1, and sensory evaluation was then carried out. The results are shown in Table 3. Besides, the term “aroma” described in the remarks in Table 3 means the fresh feeling of tomatoes in the pasta sauce and ingredients (cabbages) mixed with the pasta sauce.

TABLE 3

| Test No. | Test No. | Test No. | Test No. | Test No. | Test No. | Test No. | Test No. | Test No. |
|---|---|---|---|---|---|---|---|---|
| 18 | 19 | 20 | 21 | 22 | 23 | 24 | 25 | 26 |

Main raw materials (% by weight)

| | | | | | | | | | |
|---|---|---|---|---|---|---|---|---|---|
| Spicy seasonings(Black pepper | 0.1 | 0.1 | 0.1 | 0.1 | 0.1 | 0.1 | 0.1 | 0.1 | 0.1 |
| powder) | | | | | | | | | |
| Spicy seasonings(Roasted garlic | 0.2 | 0.2 | 0.2 | 0.2 | 0.2 | 0.2 | 0.2 | 0.2 | 0.2 |
| base) | | | | | | | | | |
| Olive oil | 30 | 30 | 30 | 30 | 30 | 30 | 30 | 30 | 30 |
| Tomato paste | 30 | 30 | 30 | 30 | 30 | 30 | 30 | 30 | 30 |
| Sugar | 3 | 3 | 3 | 3 | 3 | 3 | 3 | 3 | 3 |
| Common salt | 6 | 6 | 6 | 6 | 6 | 6 | 6 | 6 | 6 |
| Water | Balance | Balance | Balance | Balance | Balance | Balance | Balance | Balance | Balance |

Added components (% by weight)

| | | | | | | | | | |
|---|---|---|---|---|---|---|---|---|---|
| High-acidity vinegar (acetic acid: | 0 | 0.01 | 0.03 | 0.06 | 0.1 | 0.5 | 1.0 | 3.0 | 6.0 |
| 15% by weight) | | | | | | | | | |
| Total | 100 | 100 | 100 | 100 | 100 | 100 | 100 | 100 | 100 |

Acetic acid content (% by weight)

| | | | | | | | | |
|---|---|---|---|---|---|---|---|---|
| 0 | 0.0015 | 0.0045 | 0.009 | 0.015 | 0.075 | 0.15 | 0.45 | 0.9 |

Spicy flavor and fresh feeling

| | | | | | | | | |
|---|---|---|---|---|---|---|---|---|
| C | C | B | B | A | A | A | B | D |

Comprehensive evaluation

| | | | | | | | | |
|---|---|---|---|---|---|---|---|---|
| C | C | B | B | A | A | A | B | C |

Remarks

| | | | | | | | | |
|---|---|---|---|---|---|---|---|---|
| (Control) | No | Slight | Aroma | Strong | Strong | Strong | Aroma | Bitter taste and |
| | difference | aroma | | aroma | aroma | aroma | | stimulating |
| | | | | | | | | odor of ethanol |

As shown in Table 3, when the content of the acetic acid in the pasta sauce was in the range of 0.0045% to 0.45% by weight, the fresh feeling of tomatoes in the pasta sauce and ingredients (cabbages) boiled together with the pasta was felt, and the spicy flavor of the spicy seasonings was not impaired (Test Nos. 20, 21, 22, 23, 24, and 25). If the content of the acetic acid was smaller than 0.0045% by weight, the above-described effects could not be obtained (Test Nos. 18 and 19). On the other hand, if the content of the acetic acid was larger than 0.45% by weight, the stimulating odor of acetic acid came out, and regarding the taste, the acid taste of the acetic acid was felt, and the quality was impaired (Test No. 26). In the case of using vinegar (acetic acid), in particular, the fresh aroma of tomatoes in the pasta sauce and ingredients (cabbages) boiled together with the pasta came out. This is considered because, since acetic acid is a substance having high polarity, flavor components having high polarity and exhibiting fresh feeling contained in the vegetables appeared with volatilization of acetic acid having high volatility. In addition, fresh feeling derived from the vegetables was also felt strongly. This is considered because the stimulation of the nasal cavity by flavor components exhibiting fresh feeling derived from the vegetables is closely related with taste reception in the oral cavity. Besides, it was confirmed that the content of the acetic acid in Test Nos. 20 to 25 was not reduced in the process of producing the pasta sauce.

### (Test Example 4) Confirmation of Effects by Combined Use of Ethanol and Acetic Acid

The effect of enhancing spicy flavor and fresh feeling by the combined use of ethanol and acetic acid was examined. In addition, the influence of heat sterilization conditions was also examined. Pasta sauces (Test Nos. 27 to 34) were prepared in the same manner as that of Test Example 1, with the exceptions that main raw materials comprising spicy seasonings and edible fat and oil were mixed with the ethanol preparation and/or the vinegar at the mixing amounts shown in Table 4-1, and that heat sterilization was carried out under the conditions shown in Table 4-1. Using these pasta sauces, pasta was cooked in the same manner as that of Test Example 1, and sensory evaluation was then carried out. The results are shown in Table 4-1. It is to be noted that the term “aroma” for Test No. 28 described in the remarks in Table 4-2 means the fresh spicy flavor of pepper contained in the pasta sauce; the term “aroma” for Test No. 29 means the fresh feeling of tomatoes in the pasta sauce or ingredients (cabbages) mixed with the pasta sauce; and the term “aroma” for Test No. 30 means the fresh spicy flavor of pepper contained in the pasta sauce and the fresh feeling of tomatoes in the pasta sauce or ingredients (cabbages) mixed with the pasta sauce.

TABLE 4-1

| Test No. | Test No. | Test No. | Test No. | Test No. | Test No. | Test No. | Test No. |
|---|---|---|---|---|---|---|---|
| 27 | 28 | 29 | 30 | 31 | 32 | 33 | 34 |

Main raw materials (% by weight)

| | | | | | | | | |
|---|---|---|---|---|---|---|---|---|
| Spicy seasonings | 0.1 | 0.1 | 0.1 | 0.1 | 0.1 | 0.1 | 0.1 | 0.1 |
| (Black pepper powder) | | | | | | | | |
| Spicy seasonings | 0.2 | 0.2 | 0.2 | 0.2 | 0.2 | 0.2 | 0.2 | 0.2 |
| (Roasted garlic base) | | | | | | | | |
| Olive oil | 30 | 30 | 30 | 30 | 30 | 30 | 30 | 30 |
| Tomato paste | 30 | 30 | 30 | 30 | 30 | 30 | 30 | 30 |
| Sugar | 3 | 3 | 3 | 3 | 3 | 3 | 3 | 3 |
| Common salt | 6 | 6 | 6 | 6 | 6 | 6 | 6 | 6 |
| Water | Balance | Balance | Balance | Balance | Balance | Balance | Balance | Balance |

Added components (% by weight)

| | | | | | | | | |
|---|---|---|---|---|---|---|---|---|
| Ethanol preparation | 0 | 5.0 | 0 | 5.0 | 0 | 5.0 | 0 | 5.0 |
| (ethanol: 50% by weight) | | | | | | | | |
| High-acidity vinegar | 0 | 0 | 0.1 | 0.1 | 0 | 0 | 0.1 | 0.1 |
| (acetic acid: 15% by weight) | | | | | | | | |
| Total | 100 | 100 | 100 | 100 | 100 | 100 | 100 | 100 |

Ethanol content (% by weight)

| | | | | | | | |
|---|---|---|---|---|---|---|---|
| 0 | 2.5 | 0 | 2.5 | 0 | 2.5 | 0 | 2.5 |

Acetic acid content (% by weight)

| | | | | | | | |
|---|---|---|---|---|---|---|---|
| 0 | 0 | 0.015 | 0.015 | 0 | 0 | 0.015 | 0.015 |

Heat sterilization treatment

| | | | | | | | |
|---|---|---|---|---|---|---|---|
| 90° C., | 90° C., | 90° C., | 90° C., | 120° C., | 120° C., | 120° C., | 120° C., |
| 5 min | 5 min | 5 min | 5 min | 30 min | 30 min | 30 min | 30 min |
| | | | | (retorting | (retorting | (retorting | (retorting |
| | | | | sterilization) | sterilization) | sterilizayion) | sterilization) |

Spicy flavor and fresh feeling

| | | | | | | | |
|---|---|---|---|---|---|---|---|
| C | A | A | A | D | C | C | B |

Comprehensive evaluation

| | | | | | | | |
|---|---|---|---|---|---|---|---|
| C | A | A | A | D | C | C | B |

TABLE 4-2

| Test No. | Test No. | Test No. | Test No. | Test No. | Test No. | Test No. | Test No. |
|---|---|---|---|---|---|---|---|
| 27 | 28 | 29 | 30 | 31 | 32 | 33 | 34 |

Remarks

| | | | | | | | |
|---|---|---|---|---|---|---|---|
| (Control) | Strong | Strong | Strong | Strong | Strong | Strong | Heat-degradation |
| | aroma | aroma | aroma | heat-degradation | heat-degradation | heat-degradation | odor of spicy |
| | | | | odor of spicy | odor of spicy | odor of spicy | seasonings and |
| | | | | seasonings and | seasonings and | seasonings and | vegetables, |
| | | | | vegetables. | vegetables. | vegetables. | retort odor, and |
| | | | | Retort odor and | Retort odor and | Retort odor and | oxidized odor |
| | | | | oxidized odor | oxidized odor | oxidized odor | of oil. |
| | | | | of oil. | of oil. | of oil. | Spicy feeling. |
| | | | | | Slight spicy | Slight spicy | |
| | | | | | feeling. | feeling, | |

As shown in Tables 4-1 and 4-2, in the case of adding only ethanol (Test No. 28), the fresh spicy flavor of the spicy seasonings (pepper and garlic) was felt, whereas in the case of adding only acetic acid (Test No. 29), the fresh feeling of vegetables (tomatoes in the pasta sauce and ingredients (cabbages) boiled with the pasta) was felt. In the case of the combined use of ethanol and acetic acid (Test No. 30), spicy flavor and fresh feeling were felt simultaneously and also, were enhanced in comparison to the single use thereof. Furthermore, such spicy flavor and fresh feeling were enhanced as taste in the oral cavity. From these results, it was found that spicy flavor and fresh feeling were complementarily and synergistically enhanced as flavor and taste by the combined use of ethanol and acetic acid. Besides, it was confirmed that the content of the ethanol and/or the acetic acid in Test Nos. 28, 29, and 30 was not reduced in the process of producing the pasta sauce.

Further, as shown in Table 4-1 and 4-2, when the heat sterilization conditions were retorting sterilization (120° C., 30 min), the heat degradation odor of spicy seasonings and vegetables, retort odor, and the oxidized odor of oil were increased, and these odors acted to impair the quality of the pasta sauce (Test Nos. 31, 32, and 33). What is more, in the combined use of ethanol and acetic acid, when retorting sterilization was performed, the heat degradation odor of spicy seasonings and vegetables, retort odor, and the oxidized odor of oil were felt, but at the same time, spicy feeling (spicy flavor) was also felt. Thus, the effects of the combined use of ethanol and acetic acid were confirmed to a certain extent, and evaluation was enhanced (No. 34).

### (Test Example 5) Analysis of Raw Materials for Pasta Sauce and Types of Ingredients

With regard to the effect of enhancing spicy flavor and fresh feeling by the combined use of ethanol and acetic acid, whether or not the same effect can be obtained, even if there are differences in the types of spicy seasonings or aromatic materials contained in pasta sauce, the types of ingredients, and the embodiments of ethanol and acetic acid, was examined. Main raw materials comprising spicy seasonings and edible fat and oil were mixed with ethanol and/or acetic acid, and the obtained mixture was then subjected to a heat sterilization treatment (90° C. 5 min) thereby preparing pasta sauces (Test Nos. 35 to 38). These pasta sauces were stored at normal temperature for 12 months. Otherwise, immediately after the preparation thereof, the pasta sauces were used to prepare pasta in the same manner as that of Test Example 1, and sensory evaluation was then performed. The results are shown in Table 5.

TABLE 5

| | Test | Test | Test | Test |
|---|---|---|---|---|
| | No. 35 | No. 36 | No. 37 | No. 38 |
| Ingredients | Tomato | Tomato | Cabbage | Mushroom (Shimeji mushroom) |

Main raw materials of pasta sauce (% by weight)

| | | | | | |
|---|---|---|---|---|---|
| Spicy seasonings | Black pepper powder | 0.1 | 0.1 | 0.1 | 0.1 |
| | Roasted garlic base | 0.2 | 0.2 | | |
| | Diced olive | | | 3.0 | |
| | Dill | | | | 0.1 |
| Edible fat and oil | Olive oil | 30 | 30 | 30 | 30 |
| Aromatic materials | Anchovy sauce | 30 | 30 | | |
| | Pork extract | | | 12 | |
| | Fine shrimp powder | | | | 4.5 |

| | | | | |
|---|---|---|---|---|
| Water | Balance | Balance | Balance | Balance |

Added components: ethanol and/or acetic acid (% by weight)

| | | | | | |
|---|---|---|---|---|---|
| Ethanol | Ethanol preparation | 5.0 | 5.0 | | |
| | (ethanol: 50% by weight) | | | | |
| | Japanese sake | | | 15 | |
| | (ethanol: 16% by weight) | | | | |
| | White wine | | | | 20 |
| | (ethanol: 12% by weight) | | | | |
| Acetic acid | High-acidity vinegar | 0.1 | 0.1 | | |
| | (acetic acid: 15% by weight) | | | | |
| | Pure rice vinegar | | | 0.3 | |
| | (acetic acid: 4.5% by weight) | | | | |
| | Acetic acid solution | | | | 0.05 |
| | (acetic acid: 30% by weight) | | | | |

| | | | | |
|---|---|---|---|---|
| Total | 100 | 100 | 100 | 100 |

Ethanol content (% by weight)

| | | | |
|---|---|---|---|
| 2.5 | 2.5 | 2.4 | 2.4 |

Acetic acid content (% by weight)

| | | | |
|---|---|---|---|
| 0.015 | 0.015 | 0.0135 | 0.015 |

Heat sterilization treatment

| | | | |
|---|---|---|---|
| 90° C., 5 min | 90° C., 5 min | 90° C., 5 min | 90° C., 5 min |

Normal-temperature storage period

| | | | |
|---|---|---|---|
| Immediately | 12 months | 12 months | 12 months |
| after preparation | | | |

Spicy flavor and fresh feeling

| | | | |
|---|---|---|---|
| A | A | A | A |

Comprehensive evaluation

| | | | |
|---|---|---|---|
| A | A | A | A |

As shown in Table 5, regardless of differences in the types of spicy seasonings or aromatic materials contained in the pasta sauce, the types of ingredients, and the embodiments of ethanol and acetic acid, a significant effect of enhancing spicy flavor and fresh feeling was recognized, when the pasta was eaten (Test Nos. 35, 36, 37, and 38). Moreover, it was demonstrated that, even though the pasta sauce had been stored for 12 months at normal temperature after the preparation thereof, the effect was not changed and was retained (Test Nos. 36, 37, and 38). Besides, it was confirmed that content of the ethanol and the content of the acetic acid in these test samples were not reduced in the process of producing the pasta sauce and after the storage for 12 months.

One or more embodiments of the present invention can be utilized in the field of producing pasta sauce.

All publications, patents and patent applications cited in the present description are incorporated herein by reference in their entirety.

Although the disclosure has been described with respect to only a limited number of embodiments, those skilled in the art, having benefit of this disclosure, will appreciate that various other embodiments may be devised without departing from the scope of the present invention. Accordingly, the scope of the present invention should be limited only by the attached claims.

What is claimed is:

1. Pasta sauce comprising:
spicy seasoning;
edible fat and oil; and
at least one of ethanol or acetic acid.

2. The pasta sauce according to claim 1, wherein the pasta sauce comprises 0.125 to 5.0% by weight of the ethanol and/or 0.0045 to 0.45% by weight of the acetic acid.

3. The pasta sauce according to claim 1 wherein the past sauce is not emulsified.

4. The pasta sauce according to claim 1, further comprising ingredients and boiled pasta.

5. The pasta sauce according to claim 1, wherein the past sauce is sterilized by heating at a temperature lower than 100° C.

6. A method for producing pasta sauce, comprising:
preparing a mixture by adding at least one of ethanol or acetic acid to a material solution containing spicy seasoning and edible fat and oil; and
sterilizing the mixture by heating at a temperature lower than 100° C.

7. The method for producing pasta sauce according to claim 6, wherein the mixture after the sterilization comprises 0.125 to 5.0% by weight of the ethanol and/or 0.0045 to 0.45% by weight of the acetic acid.

8. The method for producing pasta sauce according to claim 6, wherein the method does not comprise an emulsification treatment.

9. The method for producing pasta sauce according to claim 6, wherein sterilizing the mixture is performed for 3 to 60 minutes.

10. A method for enhancing the spicy flavor and fresh feeling of a pasta dish, comprising mixing the pasta sauce according to claim 1 with ingredients and boiled pasta.

11. The method for enhancing the spicy flavor and fresh feeling of a pasta dish according to claim 10, wherein 3 to 30 parts by weight of the pasta sauce is mixed with 100 parts by weight of the ingredients and the boiled pasta.

12. The method for enhancing the spicy flavor and fresh feeling of a pasta dish according to claim 10, wherein the ingredients are boiled together with the pasta, or the ingredients are cooked with heat, separately from the pasta.
